(19) United States
(12) Patent Application Publication
(10) Pub. No.: US 2020/0168859 A1
(43) Pub. Date: May 28, 2020

(54) BATTERY CASE AND BATTERY

(71) Applicant: SAMSUNG ELECTRONICS CO., LTD., Suwon-si (KR)

(72) Inventors: Song Won HYUN, Yongin-si (KR); Moo Ho LEE, Suwon-si (KR); Sung Dug KIM, Suwon-si (KR); In KIM, Suwon-si (KR); Kyeong PANG, Suwon-si (KR); In Su LEE, Hwaseong-si (KR); Hye Jeong LEE, Suwon-si (KR)

(21) Appl. No.: 16/692,245

(22) Filed: Nov. 22, 2019

(30) Foreign Application Priority Data
Nov. 27, 2018 (KR) 10-2018-0148255

(51) Int. Cl. H01M 2/04; H01M 2/02

(52) U.S. Cl. CPC H01M 2/0482; H01M 2/0262

(57) ABSTRACT

Disclosed are a battery case including a container configured to accommodate an electrode assembly, wherein the container includes a bottom wall and a plurality of side walls, the bottom wall and the plurality of side walls are integrated to have an open side opposed to the bottom wall and to provide a space for accommodating the electrode assembly, the container includes a composite including a base polymer and an inorganic moisture absorbent, expanded graphite, and red phosphorus, each of which are dispersed in the base polymer, and the battery case has a water vapor transmittance rate at about 38° C. under relative humidity of about 100% according to ISO 15106 or ASTM F1249 of less than about 0.07 g/m²/day and flame retardancy of V-0 measured according to UL (Underwriter's Laboratories)-94, and a battery or battery module including an electrode assembly accommodated in the container of the battery case.

### CROSS-REFERENCE TO RELATED APPLICATION

This application claims priority to and the benefit of Korean Patent Application No. 10-2018-0148255 filed in the Korean Intellectual Property Office on Nov. 27, 2018, the entire contents of which are incorporated herein by reference.

### BACKGROUND

### 1. Field

This disclosure relates to a battery case and a battery.

### 2. Description of the Related Art

As various types of mobile electronic devices and various types of electric powered transportation, e.g., electric powered passenger or commercial vehicles, are developed, research on a power source (e.g., a battery) for supplying them with electricity (or motive power) to these devices and vehicles or means of protection from external moisture or impact is of great interest and actively being pursued. The battery may be accommodated in a case and disposed individually or used as a module in these devices or means of transportation. Accordingly, development of a technology capable of improving properties of the case is of great interest.

### SUMMARY

An embodiment provides a battery case having improved moisture transmission resistivity and flame retardancy.

Another embodiment provides a battery including the battery case.

In an embodiment, a battery case includes a container configured to accommodate an electrode assembly, wherein the container includes a bottom wall and a plurality of side walls, the bottom wall and the side walls are integrated to have an open side opposed to the bottom wall and to provide a space for accommodating the electrode assembly, the container includes a composite including a base polymer, and an inorganic moisture absorbent, expanded graphite, and red phosphorus, each of which are dispersed in the base polymer, and the battery case has a water vapor transmittance rate (WVTR) measured at about 38 degrees Celsius (° C.) under relative humidity of about 100% according to ISO 15106 or ASTM F1249 of less than about 0.07 gram per square meter per day (g/m²/day), and flame retardancy of V-0 measured according to UL (Underwriter's Laboratories)-94.

The base polymer may include a polycarbonate, a polyethylene, a polypropylene, a polyvinyl, a polyamide, a polyester, a polyphenylene sulfide (PPS), a polyphenylene ether, a polystyrene, polyimide, a polycyclic olefin copolymer, an acrylonitrile-butadiene-styrene copolymer, a liquid crystal polymer (LCP), a mixture thereof, an alloy thereof, or a copolymer thereof.

The base polymer may include a polyolefin.

The polyolefin may include a high density polyethylene.

The base polymer may further include a fluorinated polymer including polytetrafluoroethylene (PTFE), polyvinylidene fluoride (PVDF), polychlorotrifluoroethylene (PCTFE), a mixture thereof, or a copolymer thereof.

The inorganic moisture absorbent may include a silica gel, a zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂, Ba(ClO₄)₂, Ca, or a mixture of two or more.

The inorganic moisture absorbent may include CaO, MgO, a zeolite, or a mixture thereof.

A thermal expansion start temperature of the expanded graphite may be greater than or equal to an extrusion temperature of the base polymer.

The base polymer may include a high density polyethylene, and the thermal expansion start temperature of the expanded graphite may be greater than or equal to about 200° C.

The composite may further include a crystal of the same polymer as or a different polymer from the base polymer, a particle of an inorganic material different from the inorganic moisture absorbent, or a moisture barrier material that is a fiber-shaped material.

The moisture barrier material may include wollastonite, mica, cellulose whisker, barium sulfate, kaolin, talc, nanoclay, a carbon fiber, a glass fiber, or a mixture thereof.

The base polymer may be included in an amount of about 30 weight percent (wt %) to about 85 wt % based on a total weight of the composite.

The inorganic moisture absorbent may be included in an amount of less than about 30 wt % based on a total weight of the composite.

The expanded graphite may be included in an amount of less than or equal to about 30 wt % based on a total weight of the composite.

The red phosphorus may be included in an amount of less than or equal to about 25 wt % based on a total weight of the composite.

The battery case may further include a lid configured to cover at least a portion of the open side of the container and having at least one of a positive terminal and a negative terminal.

The lid may include the same composite as the container.

The container may include a plurality of cell compartments separated by at least one partition wall disposed in the space.

In another embodiment, a battery includes the battery case according to the embodiment and an electrode assembly including a positive electrode and a negative electrode accommodated in the container of the battery case.

The electrode assembly may be an electrode assembly for a rechargeable lithium battery.

The battery case according to an embodiment may have improved moisture transmission resistivity and flame retardancy by including the composite including the base polymer and the inorganic moisture absorbent, the expanded graphite, and the red phosphorus, each of which are dispersed therein. Even when a low-cost polymer material, such as, for example, a polyolefin is used as the base polymer, moisture transmission resistivity and flame retardancy may be secured, so that a battery case having a desired shape and size may be easily manufactured at a lower cost. The manufactured battery case may include a plurality of spaces in which the electrode assembly may be accommodated. A cell-module integrated battery or a battery module may be easily manufactured by directly introducing a plurality of electrode assemblies including a positive electrode and a negative electrode into the plurality of spaces without a wrapping process with a separate metal pouch to manufacture a battery cell, then injecting an electrolyte, and sealing the cell-module integrated battery or the battery module. The battery case is lightweight and has improved moisture transmission resistivity and flame retardancy, and thus may be desirably used for a rechargeable lithium battery that is susceptible to moisture and fire hazard, or for a battery module for an electric vehicle including a plurality of battery cells to provide a power with improved capacity.

### BRIEF DESCRIPTION OF THE DRAWINGS

FIG. 1 is an exploded perspective view showing a battery case according to an embodiment.

FIG. 2 is an exploded perspective view of a battery case according to an embodiment.

FIG. 3 is a photograph showing a flame retardancy test procedure according to UL-94 for an article made of HDPE alone.

FIG. 4 is a photograph showing a flame retardancy test procedure according to UL-94 for an article made of a composite including HDPE, an inorganic moisture absorbent and/or a flame retardant.

FIG. 5 is a photograph showing a flame retardancy test procedure according to UL-94 for an article made of a composite including HDPE, an inorganic moisture absorbent, and/or a flame retardant.

### DETAILED DESCRIPTION

Hereinafter, embodiments are described in detail. However, these embodiments are exemplary, the present disclosure is not limited thereto and the present disclosure is defined by the scope of claims.

If not defined otherwise, all terms (including technical and scientific terms) in the specification may be defined as commonly understood by one skilled in the art. The terms defined in a generally-used dictionary may not be interpreted ideally or exaggeratedly unless clearly defined. Accordingly, terms, such as those defined in commonly used dictionaries, should be interpreted as having a meaning that is consistent with their meaning in the context of the relevant art and the present disclosure, and will not be interpreted in an idealized or overly formal sense unless expressly so defined herein. In addition, unless explicitly described to the contrary, the word “comprise” and variations such as “comprises” or “comprising,” will be understood to imply the inclusion of stated elements but not the exclusion of any other elements.

Further, the singular includes the plural unless mentioned otherwise.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the drawings, the thickness of each element is exaggerated for better comprehension and ease of description. Like reference numerals designate like elements throughout the specification. It will be understood that when an element such as a layer, film, region, or plate is referred to as being “on” another element, it can be directly on the other element or intervening elements may also be present. In contrast, when an element is referred to as being “directly on” another element, there are no intervening elements present.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, “ ” indicates a point of attachment to an atom. Research on an electric vehicle (EV) using at least one battery system to supply a portion or all motive power is of great interest and actively being pursued. It can be expected that an electric vehicle discharges significantly less contamination material to the environment compared with a traditional vehicle operated by an internal combustion engine. Some electric vehicles using electricity use no gasoline at all or obtain entire motive power from electricity. As research on the electric vehicles increases, demands for an improved power source for vehicles, for example, an improved battery or battery module increases.

A rechargeable lithium battery capable of being charged and discharged and having high energy density can be an electrochemical device that includes a battery module for the electric vehicles. The rechargeable lithium battery operates at an elevated temperature and is vulnerable to moisture, so the battery case is mainly made of an aluminum material having improved moisture transmission resistivity. That is, an electrode assembly including positive and negative electrodes is inserted into a case, such as, an aluminum pouch or an aluminum can, and sealed to make a battery cell, and a plurality of the battery cells are used to form a battery module. However, because this method can require a complicated assembly process, extended fabrication times, and be high cost, alternative integrated cases for battery cell-modules are of interest and are needed. In addition, since a battery case prepared from a commercially available metal has a limited shape due to limits in terms of a metal manufacture technology, a battery case having a desired shape or size requires a multistep process, a high cost, and a significant amount of production time.

In order to solve the above problems, studies are being conducted on a battery case using a polymer material which is light in weight and easily molded in a desired shape. However, in case of a battery case using a polymer material, moisture transmission resistivity and mechanical strength have to be further improved. In addition, when a rechargeable lithium battery is operating at a high temperature there is a risk of explosion or fire if the internal heat inside the battery case is not efficiently discharged. A metal case, such as, aluminum, inherently has a flame retardancy, but when using a polymer material, flame retardancy is also one of the desired properties to have.

Accordingly, there has been a demand for an efficient battery case that may solve problems of heat management and moisture transmission, may be easily manufactured so as to have a desired shape and size while having a low manufacturing cost, and a battery or a battery module using the same.

The inventors disclose a battery case that is easy to mold in a desired size and shape, made of a light and low-cost polymer, and has improved moisture transmission resistivity and flame retardancy, and a battery including the same. Disclosed is a battery case molded using a composite including an inorganic moisture absorbent, expanded graphite, and red phosphorus, each of which is dispersed in a polymer matrix, having a water vapor transmittance rate (WVTR) of less than about 0.07 g/m²/day and also having a flame retardancy.

A battery case according to an embodiment includes a container configured to accommodate an electrode assembly, wherein the container includes a bottom wall and a plurality of side walls, the bottom wall and the side walls are integrated to have an open side opposed to the bottom wall and to provide a space for accommodating the electrode assembly. The container includes a composite including a base polymer, and an inorganic moisture absorbent, expanded graphite, and red phosphorus, each of which are dispersed in the base polymer, and wherein the battery case has a water vapor transmittance rate (WVTR) measured at about 38° C. under relative humidity of about 100 percent (%) according to ISO 15106 or ASTM F1249 of less than about 0.07 g/m²/day and flame retardancy of V-0 measured according to UL(Underwriter's Laboratories)-94.

The base polymer included in the battery case may be any suitable polymer as long as it has basic moisture transmission resistivity and mechanical strength, and is readily moldable. For example, the base polymer may be a polycarbonate, a polyethylene, a polypropylene, a polyvinyl, a polyamide, a polyester, a polyphenylene sulfide (PPS), a polyphenylene ether, a polystyrene, a polyimide, a polycyclic olefin copolymer, an acrylonitrile-butadiene-styrene copolymer, a liquid crystal polymer (LCP), mixture thereof, an alloy thereof, or a copolymer thereof, but is not limited thereto.

In an embodiment, the base polymer may include a polyolefin, such as, polyethylene or polypropylene, for example, high density polyethylene (HDPE).

A liquid crystal polymer known as an aromatic polyester is known to have superior moisture transmission resistivity and basic flame retardancy to a polyolefin, for example, a high density polyethylene (HDPE). However, the liquid crystal polymer is generally more expensive than the polyolefin, and thus involves a high manufacturing cost. On the contrary, the polyolefin is a less expensive polymer than the liquid crystal polymer but has a moisture resistivity because of its crystalline region that plays as a barrier for delaying moisture permeation. In addition, by further reinforcing moisture resistivity, flame retardancy, and the like, the polyolefin may also be used to reduce production cost of a composite for a battery case along with the liquid crystal polymer and the like.

In an embodiment, the base polymer may further include a fluorinated polymer. The fluorinated polymer may be polytetrafluoroethylene (PTFE), polyvinylidene fluoride (PVDF), polychlorotrifluoroethylene (PCTFE), or a mixture thereof, or a copolymer. When the base polymer includes a fluorinated polymer, a container of a battery case manufactured therefrom may have a further improved water vapor transmittance resistance.

The fluorinated polymer has hydrophobicity, and thus, when the fluorinated polymer is included in an amount of less than or equal to about 20 wt %, for example, less than or equal to about 15 wt %, less than or equal to about 10 wt %, for example, about 3 wt % to about 10 wt %, or about 5 wt % to about 10 wt % based on a total weight of the composite, an article produced therefrom may have an effect of blocking moisture from a surface of the article that is in contact with the outside air.

An amount of the base polymer in the composite forming the container of the battery case may be about 30 wt % to about 85 wt %, for example, about 35 wt % to about 85 wt %, about 40 wt % to about 85 wt %, about 45 wt % to about 85 wt %, about 50 wt % to about 85 wt %, about 55 wt % to about 85 wt %, about 60 wt % to about 85 wt %, about 60 wt % to about 80 wt %, about 65 wt % to about 80 wt %, about 65 wt % to about 75 wt %, or about 70 wt % to about 75 wt % based on a total weight of the composite, but is not limited thereto.

When an amount of the base polymer is less than about 30 wt %, it may not be molded into a battery case and it may be difficult to satisfy basic mechanical properties. When an amount of the base polymer is greater than about 85 wt %, it may be difficult to obtain moisture transmission resistivity and flame retardancy.

The inorganic moisture absorbent may include at least one of a silica gel, a zeolite, CaO, BaO, MgSO₄, Mg(ClO₄)₂, MgO, P₂O₅, Al₂O₃, CaH₂, NaH, CaSO₄, Na₂SO₄, CaCO₃, K₂CO₃, CaCl₂, Ba(ClO₄)₂, and Ca.

In an embodiment, the inorganic moisture absorbent may include a zeolite, CaO, MgO, or a combination thereof, for example, the inorganic moisture absorbent may be CaO or MgO.

A zeolite having various pore sizes is commercially available, and when the battery case according to an embodiment includes a zeolite as an inorganic moisture absorbent, the zeolite having a pore size ranging from about 3 angstrom (Å) to about 10 Å, for example, about 3 Å to about 8 Å, about 3 Å to about 7 Å, or about 3 Å to about 5 Å may be used. Since a water molecule has a size of about 3.8 Å, the water molecule may be easily trapped in the pores of the zeolite. In addition, the zeolite may have an average particle diameter ranging from about 2 micrometer (μm) to about 10 μm, and include aluminum in an amount of greater than or equal to about 40 wt %. When the amount of aluminum is larger than the range, improved hygroscopicity may be exhibited.

When the inorganic moisture absorbent is CaO, a particle size of CaO may be about 0.1 μm to about 20 μm, for example, about 0.1 μm to about 15 μm, about 0.1 μm to about 10 μm, about 0.1 μm to about 8 μm, about 0.1 μm to about 7 μm, about 0.1 μm to about 6 μm, about 0.1 μm to about 5 μm, about 0.1 μm to about 4 μm, about 0.1 μm to about 3 μm, about 0.1 μm to about 2 μm, or about 0.1 μm to about 1 μm, but is not limited thereto. When the particle size of CaO is greater than about 20 μm, the moisture transmission resistivity may get decreased.

A zeolite is a physical moisture absorbent absorbing water through a particle having pores, while CaO is a chemical water adsorbent adsorbing water through a chemical reaction with a water molecule. Accordingly, in an embodiment, as the inorganic moisture absorbent, a zeolite and CaO may be used together.

The inorganic moisture absorbent may be included in an amount of less than about 30 wt %, for example, about 1 wt % to about 28 wt %, about 5 wt % to about 25 wt %, about 5 wt % to about 20 wt %, about 5 wt % to about 18 wt %, about 5 wt % to about 15 wt %, about 7 wt % to about 15 wt %, about 8 wt % to about 15 wt %, about 8 wt % to about 13 wt %, or about 10 wt % based on a total weight of the composite, but is not limited thereto.

When the inorganic moisture absorbent is included in an amount of less than about 1 wt %, a moisture transmission resistivity effect may not be obtained, or the amount thereof may be so small which may shorten moisture transmission resistivity cycle-life of a battery which is supposed to be used for greater than or equal to about 10 years and may result in no moisture transmission resistivity performance. On the contrary, as the inorganic moisture absorbent is used in an amount of greater than or equal to about 30 wt %, the inorganic moisture absorbent itself may be aggregated or become hydrophilic on the surface, and thus may reduce the moisture transmission resistivity, and in addition, decrease in impact strength of an article may be severe, and moldability may be deteriorated.

Expanded graphite is a graphite treated with a strong acid, for example, sulfuric acid and the like, and includes a component, for example, oxygen and the like, among layers thereof. The component such as oxygen and the like included among layers may get gasified and may expand during a combustion, and may form a char, which may work as an insulation layer and may hinder a heat transfer and may block an oxygen supply, and accordingly, may play a role in suppressing the combustion. Expanded graphite is well known as a non-halogen type low fuming environmentally-friendly flame retardant.

On the other hand, the red phosphorus indicates phosphorus having a color of red and is obtained as red powder by heating yellow phosphorus under an inert gas. The red phosphorus, consisting of only phosphorus elements as shown in Chemical Formula 1, has an ignition temperature of about 260° C. in the air, and is chemically stable and unreactive.

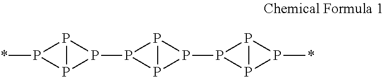 [SMILES: *p1p2p(-p3p4p(-p5p6p(*)p56)p34)p12]

When this red phosphorus is combusted at greater than or equal to about 260° C., the it is decomposed into phosphoric acid, which may form a char through a condensation reaction and thus may block external oxygen and heat like the expanded graphite. In addition, as described above, the red phosphorus needs oxygen to be combusted and decomposed into phosphoric acid, and thus may play a role of hindering a combustion reaction. Accordingly, red phosphorus is also widely used as a type of phosphorus-based flame retardant.

However, when the battery case according to an embodiment is manufactured by including either one of the two flame retardant components of the expanded graphite and the red phosphorus, the desired flame retardancy may not be obtained. However, when these two components are used together, the desired flame retardancy is unexpectedly improved. Without being bound to a specific theory, a reason of not securing desired flame retardancy, when either expanded graphite or red phosphorus, known as a conventional flame retardant, is used alone, is that the battery case according to an embodiment includes an inorganic moisture absorbent in order to secure moisture transmission resistivity, and this inorganic moisture absorbent has reactivity towards the flame retardant components, and thus a flame retardancy effect may not be obtained. However, when both the flame retardants are used together, their reactivity towards the inorganic moisture absorbent may be suppressed or completely diminished, and accordingly, moisture transmission resistivity due to the inorganic moisture absorbent may be obtained, as well as excellent flame retardancy may also be secured. The battery case according to an embodiment may include a base polymer, an inorganic moisture absorbent, and both expanded graphite and red phosphorus as a flame retardant component.

The expanded graphite may expand at greater than or equal to a molding temperature of the base polymer. In other words, an expansion temperature of the expanded graphite may be greater than or equal to the molding temperature of the base polymer. When the expansion temperature of the expanded graphite is less than or equal to the molding temperature of the base polymer, the expanded graphite may expand in advance during a molding process of a composite including the base polymer, the inorganic moisture absorbent, and both, expanded graphite and red phosphorus. Therefore, an article including the composite may not secure flame retardancy, because the expanded graphite has no aforementioned char formation and oxygen-blocking effect and the like due to the expansion during a combustion. Accordingly, the expanded graphite should preferably expand at a temperature higher than a molding temperature of a base polymer and thus may be selected depending on the type of the base polymer. For example, in an embodiment, when high density polyethylene (HDPE) is used as a base polymer, an expansion temperature of the expanded graphite may be about 200° C., which is higher than 170° C., an extrusion temperature of HDPE.

The expanded graphite may be included in an amount of less than or equal to about 30 wt %, for example, less than or equal to about 28 wt %, less than or equal to about 27 wt %, less than or equal to about 25 wt %, less than or equal to about 23 wt %, less than or equal to about 20 wt %, less than or equal to about 18 wt %, or less than or equal to about 15 wt %, for example, greater than or equal to about 1 wt %, greater than or equal to about 3 wt %, greater than or equal to about 5 wt %, greater than or equal to about 7 wt %, or greater than or equal to about 10 wt %, for example, greater than or equal to about 1 wt % and less than or equal to about 30 wt %, greater than or equal to about 3 wt % and less than or equal to about 30 wt %, greater than or equal to about 5 wt % and less than or equal to about 30 wt %, greater than or equal to about 5 wt % and less than or equal to about 27 wt %, greater than or equal to about 5 wt % and less than or equal to about 25 wt %, greater than or equal to about 5 wt % and less than or equal to about 23 wt %, greater than or equal to about 5 wt % and less than or equal to about 20 wt %, greater than or equal to about 5 wt % and less than or equal to about 18 wt %, greater than or equal to about 5 wt % and less than or equal to about 15 wt %, greater than or equal to about 7 wt % and less than or equal to about 25 wt %, greater than or equal to about 7 wt % and less than or equal to about 20 wt %, greater than or equal to about 7 wt % and less than or equal to about 18 wt %, greater than or equal to about 7 wt % and less than or equal to about 15 wt %, greater than or equal to about 7 wt % and less than or equal to about 13 wt %, greater than or equal to about 8 wt % and less than or equal to about 12 wt %, or about 10 wt % based on a total weight of the composite, but is not limited thereto.

The red phosphorus may be included in an amount of less than or equal to about 25 wt %, for example, less than or equal to about 23 wt %, less than or equal to about 22 wt %, less than or equal to about 20 wt %, less than or equal to about 18 wt %, or less than or equal to about 15 wt %, for example, greater than or equal to about 1 wt %, greater than or equal to about 3 wt %, greater than or equal to about 5 wt %, greater than or equal to about 7 wt %, or greater than or equal to about 10 wt %, for example, greater than or equal to about 1 wt % and less than or equal to about 25 wt %, greater than or equal to about 3 wt % and less than or equal to about 25 wt %, greater than or equal to about 3 wt % and less than or equal to about 20 wt %, greater than or equal to about 5 wt % and less than or equal to about 20 wt %, greater than or equal to about 5 wt % and less than or equal to about 18 wt %, greater than or equal to about 5 wt % and less than or equal to about 15 wt %, greater than or equal to about 5 wt % and less than or equal to about 13 wt %, greater than or equal to about 7 wt % and less than or equal to about 20 wt %, greater than or equal to about 7 wt % and less than or equal to about 18 wt %, greater than or equal to about 7 wt % and less than or equal to about 15 wt %, greater than or equal to about 7 wt % and less than or equal to about 13 wt %, greater than or equal to about 7 wt % and less than or equal to about 10 wt %, or about 10 wt % based on a total weight of the composite, but is not limited thereto.

In an embodiment, the expanded graphite may be included in an amount of about 3 wt % to about 30 wt %, for example, about 5 wt % to about 25 wt %, or about 5 wt % to about 20 wt % based on a total weight of the composite, and the red phosphorus may be included in an amount of about 3 wt % to about 25 wt %, for example, about 3 wt % to about 20 wt %, or about 5 wt % to about 20 wt % based on a total weight of the composite.

When the expanded graphite and the red phosphorus are included respectively within the ranges, the battery case according to an embodiment may secure improved flame retardancy along with improved moisture transmission resistivity.

The battery case according to an embodiment may include the composite including a base polymer, and an inorganic moisture absorbent, expanded graphite, and red phosphorus which are dispersed in the base polymer, and may have a water vapor transmittance rate (WVTR) of less than about 0.07 g/m²/day which is measured at about 38° C. under relative humidity of about 100% according to ISO 15106 and ASTM F1249, and flame retardancy of V-0 which is measured according to UL-94.

In an embodiment, the water vapor transmittance rate of the battery case may be reduced down to about 0.06 g/m²/day, for example, less than or equal to about 0.05 g/m²/day, less than or equal to about 0.04 g/m²/day, less than or equal to about 0.03 g/m²/day, less than or equal to about 0.025 g/m²/day, less than or equal to about 0.02 g/m²/day, less than or equal to about 0.015 g/m²/day, or less than or equal to about 0.010 g/m²/day by adjusting an amount of the base polymer, a type and an amount of the inorganic moisture absorbent, an amount of the red phosphorus and the expanded graphite, and the like, but the present disclosure is not limited thereto.

The battery case according to an embodiment has similar moisture transmission resistivity to that of a metal pouch-shaped exterior material conventionally wrapping an electrode for a rechargeable lithium battery assembly. The battery case according to an embodiment may be used to manufacture a cell-module integrated battery by directly introducing a separately-manufactured electrode assembly into the battery case without wrapping it with an additional exterior material such as a metal pouch and the like.

UL (Underwriter's Laboratories)-94 is a reference for evaluating flame retardancy of plastic, and used to evaluate a combustion aspect of a plastic article and a flame spread degree around the plastic article when a flame is applied in a vertical direction of the plastic article (a vertical burning test). The evaluation reference according to UL-94 is classified into V-0 rating, when the flame applied in a vertical direction of the plastic product is extinguished within 30 seconds and does not drop and ignite on a cotton, and into V-1 rating, when the flame is extinguished within 60 seconds and does not drop and ignite on the cotton, and into V-2 rating, when the flame is extinguished within 60 seconds but ignites on the cotton. When the above ratings are not satisfied at all, it may be classified as a non-flame retardant.

As shown from Examples and Comparative Examples which are described below, articles of the Examples manufactured by using a composite including a base polymer and an inorganic moisture absorbent, expanded graphite, and red phosphorus dispersed in the base polymer exhibit flame retardancy rating of V-0. However, articles of the Comparative Examples including neither red phosphorus nor expanded graphite or only including either one of red phosphorus or expanded graphite do not correspond to any rating of V-0 to V-2, but are classified as non-flame retardant. Similarly, when ammonium polyphosphate, which is conventionally known as a phosphorus-based flame retardant, is used instead of the red phosphorus along with expanded graphite, the same non-flame retardancy as described above is obtained. Accordingly, a significant improvement in flame retardancy may be achieved by including red phosphorus as a phosphorus-based flame retardant, along with expanded graphite.

The composite may further include a material conventionally known as a moisture-barrier material. The moisture barrier material may include, for example, a crystalline form of the same polymer as or a different polymer from the base polymer in the composite, a particle of an inorganic material different from the inorganic moisture absorbent, or a fiber-shaped material, such as, for example, a glass fiber or a carbon fiber. Specific examples of the moisture barrier material may be wollastonite, mica, cellulose whisker, barium sulfate, kaolin, talc, nanoclay, a carbon fiber or a glass fiber having an aspect ratio of greater than or equal to about 100, or a mixture thereof, but are not limited thereto. These moisture barrier materials may be included in an amount of less than or equal to about 10 wt %, for example, about 1 wt % to about 10 wt %, about 1 wt % to about 8 wt %, or about 1 wt % to about 5 wt % based on a total weight of the composite.

In an embodiment, a container of the battery case may include a plurality of cell compartments partitioned by at least one partition wall disposed in the space, and accordingly, a battery module including a plurality of battery cells may be manufactured by respectively introducing the plurality of battery cells into the plurality of cell compartments of the battery case without respectively wrapping the plurality of battery cells with a metal pouch and the like after manufacturing the plurality of battery cells. In an embodiment, the battery case may be a cell-module integrated battery case.

Conventionally, an electrode assembly including positive and negative electrodes is formed and then, wrapped with a metal pouch having moisture transmission resistivity to form a battery cell, and then, packed in a metallic battery case to manufacture a battery module, which is complicated in terms of a process, takes a long time, and with increasingly high costs. As aforementioned, the battery case according to an embodiment to manufacture a cell-module integrated battery, may have a great time- and cost-reducing effect in terms of a manufacturing cost and time of a battery module compared with a conventional metal battery case and a battery using the same. In addition, the battery case according to an embodiment may include a polymer material as a main component, and thus, may have a light weight and a freedom of shape, may be manufactured at a low cost, and in addition, may exhibit excellent flame retardancy.

In an embodiment, the battery case may be a battery case for a rechargeable lithium battery, but is not limited thereto, and may be a case for a battery accommodating a plurality of electrode assemblies and requiring moisture transmission resistivity.

In an embodiment, the battery case may further include for example a lid configured to cover at least a portion of the open side of the container and having at least one of a positive terminal and a negative terminal. The lid may have at least one of a positive terminal and a negative electrode terminal, for example, both of the positive terminal and the negative electrode terminal, whereby the battery in the battery case may be electrically connected to outside of the battery case. The lid may include the same material as the container, or the lid may include a different material from the container.

Hereinafter, a battery case according to an embodiment is described with reference to the appended drawings.

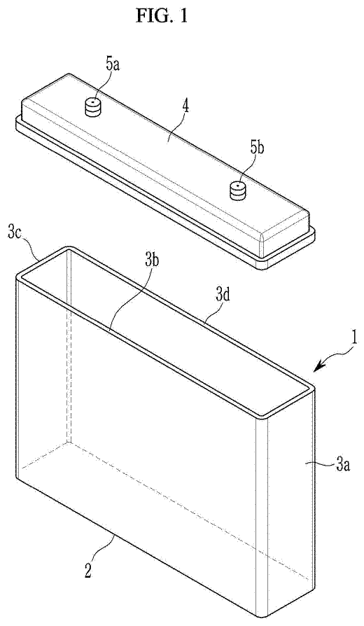

FIG. 1 is an exploded perspective view showing a battery case according to an embodiment.

Referring to FIG. 1, a battery case according to an embodiment includes a container 1 including a bottom wall 2 and a plurality of (e.g., 3, 4, or greater) side walls 3a, 3b, 3c, and 3d that are integrated to provide a space for accommodating an electrode assembly. The container 1 has an open side opposed to the bottom wall 2 and an electrode assembly may be accommodated in the container 1 through the open side.

Herein, “integrated” indicates a state that the bottom wall is connected to the plurality of side walls, and thus all the other sides except for the open side provide a closed and sealed space. A method for this integration is not particularly limited but may include, for example, as described below, a method of preparing a composite including a base polymer and an inorganic moisture absorbent, expanded graphite, and red phosphorous, which are dispersed in the base polymer, and molding the composite to integrate the bottom wall and the plurality of side walls and to provide a container having a space for accommodating electrodes, or a method of separately molding the bottom wall and the plurality of side walls, and then, connecting them in a publicly known method, such as, welding, boning, or the like. As described above, the method for integration is not limited to a particular method, but may include various suitable methods known to those of ordinary skilled in the art, through which a container of a battery case is fabricated to have a space for accommodating an electrode assembly by integrating the bottom wall and the plurality of side walls.

The battery case may further include a lid 4 to cover (e.g., seal) at least a portion, for example, a whole portion of the open side of the container 1. The lid 4 may have at least one of the positive terminal 5a and the negative terminal 5b (e.g., positive terminal and negative terminal). The lid 4 may include the same material as the container 1 or a different material from the container 1, and the battery case according to an embodiment may be entirely sealed by covering the open side of the container 1 with the lid 4 and sealing the same.

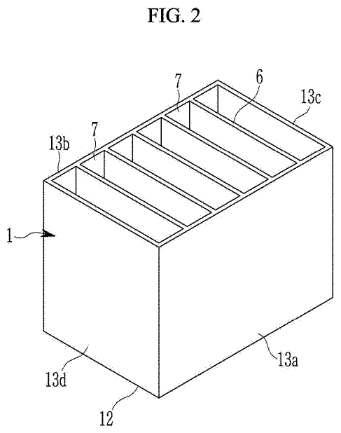

FIG. 2 is an exploded perspective view of a battery case according to another embodiment.

Referring to FIG. 2, a container 1 of a battery case according to an exemplary embodiment has a space formed by integrating a bottom wall 12 with a plurality of side walls (e.g., 3, 4, or more) 13a, 13b, 13c, and 13d, and an open side facing the bottom wall 12, and in the space, at least one partition wall 6 (e.g., 2, 3, 4, 5, or more) is provided. The container may include a plurality of (e.g., greater than or equal to 2, for example, greater than or equal to 3, for example, greater than or equal to 4, or for example, greater than or equal to 5) cell compartments 7 defined by the partition wall 6. Each battery cell compartment 7 may include the electrode assembly that will be described below, and a battery module may be fabricated by accommodating at least two electrode assemblies in each battery cell compartment and injecting an electrolyte solution therein. After disposing the electrode assembly and injecting the electrolyte solution, the open side of the container 1 may be covered or sealed with a lid, which is not shown.

FIGS. 1 and 2 show the container 1 of the parallelepiped battery case, but the battery case according to an embodiment has no limit to the shape, but may have various shapes and sizes and the various numbers of containers and cell compartments.

Another embodiment provides a battery including the battery case and an electrode assembly accommodated in the container of the battery case and including a positive electrode and a negative electrode. Details for the battery case are the same as described above.

Hereinafter, the electrode assembly is described.

The electrode assembly may include a positive electrode, a negative electrode, and a separator disposed therebetween. The electrode assembly may further include, for example, an aqueous or non-aqueous electrolyte solution in the separator. The types of the electrode assembly are not particularly limited. In an embodiment, the electrode assembly may include an electrode assembly for a rechargeable lithium battery. The positive electrode, the negative electrode, the separator, and the electrolyte solution of the electrode assembly may be appropriately selected according to types of the electrode and are not particularly limited. Hereinafter, the electrode assembly for a rechargeable lithium battery is exemplified, but the present disclosure is not limited thereto.

The positive electrode may include, for example, a positive active material disposed on a positive current collector and may further include at least one of a conductive material and a binder. The positive electrode may further include a filler. The negative electrode may include, for example a negative active material disposed on a negative current collector and may further include at least one of a conductive material and a binder. The negative electrode may further include a filler.

The positive active material may include, for example a (solid solution) oxide including lithium but is not particularly limited as long as it is a material capable of intercalating and de-intercalating lithium ions electrochemically. The positive active material may be a layered compound such as lithium cobalt oxide (LiCoO₂), lithium nickel oxide (LiNiO₂), and the like, a compound substituted with one or more transition metal; a lithium manganese oxide such as chemical formula Li₁₊ₓMn₂₋ₓO₄ (wherein, x is 0 to 0.33), LiMnO₃, LiMn₂O₃, LiMnO₂, and the like; lithium copper oxide (Li₂CuO₂); vanadium oxide such as LiV₃O₈, LiFe₃O₄, V₂O₅, Cu₂V₂O₇, and the like; a Ni site-type lithium nickel oxide represented by chemical formula LiNi₁₋ₓMₓO₂ (wherein, M is Co, Mn, Al, Cu, Fe, Mg, B, or Ga and x is 0.01 to 0.3); a lithium manganese composite oxide represented by chemical formula LiMn₂₋ₓMₓO₂ (wherein, M is Co, Ni, Fe, Cr, Zn, or Ta and x is 0.01 to 0.1) or Li₂Mn₃MO₈ (wherein, M is Fe, Co, Ni, Cu, or Zn); LiMn₂O₄ where a part of Li of chemical formula is substituted with an alkaline-earth metal ion; a disulfide compound; Fe₂(MoO₄)₃, and the like, but is not limited thereto.

Examples of the conductive material may include carbon black, for example, ketjen black, acetylene black, and the like, natural graphite, artificial graphite, and the like, but is not particularly limited as long as it may increase conductivity of the positive electrode.

The binder may be, for example, polyvinylidene fluoride, an ethylene-propylene-diene terpolymer, a styrene-butadiene rubber, an acrylonitrile-butadiene rubber, a fluorine rubber, polyvinyl acetate, polymethyl methacrylate, polyethylene, nitrocellulose, and the like, but is not particularly limited as long as it may bind the (positive or negative) active material and the conductive material on the current collector. Examples of the binder may be polyvinyl alcohol, carboxylmethyl cellulose (CMC), starch, hydroxypropyl cellulose, recycled cellulose, tetrafluoroethylene, polyethylene, polypropylene, an ethylene-propylene-diene terpolymer (EPDM), sulfonated EPDM, a styrene-butene rubber, a fluorine rubber, various copolymers, polymeric highly saponified polyvinyl alcohol, and the like, in addition to the foregoing materials.

The negative active material may be, for example, carbon and graphite materials, for example, natural graphite, artificial graphite, expanded graphite, carbon fiber, non-graphizable carbon, carbon black, carbon nanotube, fullerene, activated carbon, and the like; a metal, such as, Al, Si, Sn, Ag, Bi, Mg, Zn, In, Ge, Pb, Pd, Pt, Ti, and the like that may be an alloy with lithium and a compound including such an element; a composite material of a metal and a compound thereof and carbon and graphite materials; a lithium-containing nitride, and the like. Carbon-based active materials, silicon-based active materials, tin-based active materials, or silicon-carbon-based active materials may be desirably used, and may be used alone or in a combination of two or more.

The separator is not particularly limited and may be any suitable separator of a rechargeable lithium battery. For example, a porous film or non-woven fabric having high rate discharge performance may be used alone or in a mixture thereof. The separator may include pores, and the pores may have a pore diameter of about 0.01 μm to about 10 μm, and a thickness of about 5 μm to about 300 μm. A substrate of the separator may include, for example, a polyolefin, a polyester, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, and the like. When the electrolyte is a solid electrolyte, such as, a polymer, the solid electrolyte may function as a separator.

The conductive material is a component to further improve conductivity of an active material and may be included in an amount of about 1 wt % to about 30 wt % based on a total weight of the electrode, but is not limited thereto. Such a conductive material is not particularly limited as long as it does not cause chemical changes of a battery and has suitable conductivity, and may be for example, graphite, such as, natural graphite or artificial graphite; carbon black, such as carbon black, acetylene black, ketjen black, channel black, furnace black, lamp black, summer black, and the like; a carbon derivative, such as a carbon nanotube, fullerene, and the like, a conductive fiber, such as a carbon fiber or a metal fiber, and the like; carbon fluoride, a metal powder, such as aluminum, a nickel powder, and the like; a conductive whisker, such as zinc oxide, potassium titanate, and the like; a conductive metal oxide, such as a titanium oxide; and a conductive material, such as a polyphenylene derivative, and the like.

The filler is an auxiliary component to suppress expansion of an electrode, is not particularly limited as long as it does not cause chemical changes of a battery, and is a fiber-shaped material, and may be for example, an olefin-based polymer, such as, polyethylene, polypropylene, and the like; a fiber-shaped material, such as, a glass fiber, a carbon fiber, and the like.

In the electrode, the current collector may be a site where electron transports in an electrochemical reaction of the active material and may be a negative current collector and a positive current collector according to types of the electrode. The negative current collector may have a thickness of about 3 μm to about 500 μm. The negative current collector is not particularly limited as long as it does not cause chemical changes of a battery and has conductivity and may be, for example, copper, stainless steel, aluminum, nickel, titanium, fired carbon, copper or stainless steel that is surface-treated with carbon, nickel, titanium, silver, or the like, an aluminum-cadmium alloy, and the like.

The positive current collector may have a thickness of about 3 μm to about 500 μm, but is not limited thereto. Such a positive current collector is not particularly limited as long as it does not cause chemical changes of a battery and has high conductivity and may be, for example, stainless steel, aluminum, nickel, titanium, fired carbon, or aluminum or stainless steel that is surface-treated with carbon, nickel, titanium, silver, or the like.

The current collectors may have a fine concavo-convex form on its surface to reinforce a binding force of the active material and may be used in various shapes of a film, a sheet, a foil, a net, a porous film, a foam, a non-woven fabric, or the like.

The lithium-containing non-aqueous electrolyte solution may include or consist of a non-aqueous electrolyte and a lithium salt.

The non-aqueous electrolyte may be, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and the like.

The lithium salt is a material that is dissolved in the non-aqueous electrolyte solution and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloro borane, lower aliphatic lithium carbonate, lithium tetra-phenyl borate, imides, and the like.

An organic solid electrolyte, an inorganic solid electrolyte, and the like may be used as needed.

The organic solid electrolyte may be, for example, a polyethylene derivative, a polyethylene oxide derivative, a polypropylene oxide derivative, a phosphoric acid ester polymer, a poly(L-lysine, a polyester sulfide, polyvinyl alcohol, polyvinylidene fluoride, a polymer including an ionic leaving group, and the like.

The inorganic solid electrolyte may be, for example, nitrides of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, and the like, halides, sulfates, and the like.

The non-aqueous electrolyte solution may include, for example, pyridine, triethylphosphite, triethanolamine, cyclic ether, ethylene diamine, n-glyme, hexa phosphoric triamide, a nitrobenzene derivative, sulfur, a quinone imine dye, N-substituted oxazolidinone, N,N-substituted imidazolidine, an ethylene glycol dialkyl ether, an ammonium salt, pyrrole, 2-methoxy ethanol, or aluminum trichloride in order to improve charge and discharge characteristics, flame retardancy, and the like. As needed, in order to endow inflammability, a halogen-containing solvent such as, carbon tetrachloride, ethylene trifluoride, and the like may be further added and in order to improve high temperature storage characteristics, carbon dioxide gas may be further added.

As described above, a battery including a battery case according to an embodiment may not need manufacture of a unit cell including exterior materials consisting of additional moisture transmission resistance materials on each electrode assembly, and thus an electrode assembly accommodated in the container of the battery case may not need additional exterior materials.

The battery case according to an embodiment may be easily manufactured from the composite including the base polymer and the inorganic moisture absorbent, the expanded graphite, and the red phosphorus which are dispersed in the base polymer. For example, the composite including the base polymer and the inorganic moisture absorbent, the expanded graphite, and the red phosphorus which are dispersed in the base polymer may be molded into the battery case according to an embodiment to have desired size and shape in various plastic molding methods known in the related art, for example, extrusion molding, injection molding, blow molding, press molding, and the like. A battery according to an embodiment may be easily manufactured by accommodating a separately manufactured electrode assembly including positive and negative electrodes in a container of the battery case, injecting an electrolyte solution into the battery container accommodating the electrode assembly, and then, sealing the battery case.

The battery-manufacturing method may not need a process of packing an electrode assembly with a conventional metal exterior material and may include simplified process steps and may provide a battery or battery module in fast and efficient manner. Particularly, the battery case may be manufactured by forming at least one partition wall inside a space of the battery container to conveniently include at least two cell compartments partitioned by the at least one partition wall up to desired number and size. The electrode assemblies manufactured up to the desired number and size may be easily introduced into at least two cell compartments without wrapping with an additional metal pouch and the like to manufacture a battery module including the desired number of electrode assemblies. This manufactured battery module has a much reduced entire weight due to a light weight of the battery case, and thus may contribute to energy efficiency.

Hereinafter, the embodiments are described with reference to examples and comparative examples. The following examples and comparative examples are exemplary but do not limit the scope of the present disclosure.

### EXAMPLES

### Preparation and Evaluation of Composite for Battery Case

High density polyethylene (HDPE) having a weight average molecular weight of greater than or equal to about 10⁵ gram per mole (g/mol), as a base polymer, calcium oxide (CaO) (an average particle size of 3 μm) (ANFOGEN #600H, Hwasung Chemical Co., Ltd.) and magnesium oxide (MgO) (an average particle size of 3.5 μm) (STARMAG #150, Konoshima Chemical Co., Ltd.), as inorganic moisture absorbents, and red phosphorus, ammonium polyphosphate (APP), and expanded graphite having a thermal expansion-starting temperature of 200° C., as flame retardants, are prepared.

The components are mixed in ratios shown in Table 1, and respectively injection-molded, and then, a water vapor transmittance rate and a flame retardant rating of articles manufactured therefrom are measured, and the results are shown in Table 1.

Specifically, each component shown in Table 1 is introduced into an extruder having two screw axes, and then, melted and mixed to manufacture pellets. A temperature profile of the extruder is controlled by dividing a temperature from 160° C. at an inlet to 240° C. at an outlet into six zones, and the screws are controlled at a speed of 60 to 100 revolutions per minute (rpm).

The pellets are put and molded in an injector to manufacture disk-shaped articles having a thickness of about 1 millimeters (mm) and a diameter of 30 mm. Each article is measured regarding a water vapor transmittance rate at 38° C. under relative humidity of 100% by using an Aquatran equipment (Mocon Inc.) according to ISO15106-3, and regarding flame retardancy according to UL-94, and the results are shown in Table 1.

TABLE 1

| | | Inorganic | | Types and amounts | | | Water | |
|---|---|---|---|---|---|---|---|---|
| | | moisture | | of flame retardant | | | vapor | Flame |
| | | absorbent | | (wt %) | | | transmit- | retardant |
| | HDPE | (wt %) | | Red | | Expanded | tance rate | rating |
| | (wt %) | CaO | MgO | phosphorus | APP* | graphite | (g/m²/day) | (UL94) |
| Example 1 | 70 | 10 | 0 | 10 | 0 | 10 | 0.007 | V-0 |
| Example 2 | 75 | 5 | 0 | 10 | 0 | 10 | 0.012 | V-0 |
| Example 3 | 70 | 0 | 10 | 10 | 0 | 10 | 0.020 | V-0 |
| Example 4 | 60 | 20 | 0 | 10 | 0 | 10 | 0.006 | V-0 |
| Example 5 | 60 | 10 | 0 | 10 | 0 | 20 | 0.008 | V-0 |
| Example 6 | 65 | 10 | 0 | 20 | 0 | 5 | 0.015 | V-0 |
| Comparative | 80 | 0 | 0 | 10 | 0 | 10 | 0.250 | V-0 |
| Example 1 | | | | | | | | |
| Comparative | 70 | 10 | 0 | 20 | 0 | 0 | 0.010 | NG |
| Example 2 | | | | | | | | |
| Comparative | 70 | 10 | 0 | 0 | 0 | 20 | 0.013 | NG |
| Example 3 | | | | | | | | |
| Example 4 | 90 | 10 | 0 | 0 | 0 | 0 | 0.008 | NG |
| Example 5 | 80 | 0 | 10 | 10 | 0 | 0 | 0.021 | NG |
| Comparative | 70 | 10 | 0 | 0 | 10 | 10 | 0.070 | NG |
| Example 6 | | | | | | | | |

(APP*: ammonium polyphosphate; NG: Not Good)

As shown in Table 1, articles manufactured from the composites according to Examples 1 to 6 including a base polymer, an inorganic moisture absorbent, and red phosphorus and expanded graphite as a flame retardant according to an embodiment exhibit a water vapor transmittance rate of less than 0.07 g/m²/day and a flame retardant rating of V-0 according to UL-94, and thus, have excellent moisture transmission resistivity and flame retardancy.

On the other hand, an article of Comparative Example 1 including red phosphorus and expanded graphite as a flame retardant in the same amount as that of Example 1, but no inorganic moisture absorbent, achieves flame retardancy of V-0 rating but exhibits moisture transmission resistivity of 0.250 g/m²/day, and accordingly, may not be used as a battery case.

In addition, Comparative Examples 2 and 3 including a base polymer and an inorganic moisture absorbent as the same component and amount as Example 1 but either one of red phosphorus or expanded graphite is in an amount of 20 wt % as a flame retardant, exhibit improved moisture transmission resistivity but secure no flame retardancy. This result is similar to that of Comparative Example 4 including 10 wt % of an inorganic moisture absorbent but no flame retardant in a base polymer. Comparative Example 4 achieves moisture transmission resistivity but no flame retardancy at all. Surprisingly, Comparative Examples 2 and 3 including either one of red phosphorus or expanded graphite conventionally known as a flame retardant in a high amount of 20 wt % exhibit no flame retardancy, just like Comparative Example 4.

In addition, an article of Comparative Example 5, including MgO instead of CaO as an inorganic moisture absorbent and 10 wt % of red phosphorus as a flame retardant also achieves moisture transmission resistivity but no flame retardancy.

Lastly, Comparative Example 6, including a base polymer, an inorganic moisture absorbent, and expanded graphite in the same components and the same amount as Example 1 but ammonium phosphate (APP) instead of the red phosphorus as a phosphorus-based flame retardant but in the same amount as that of the red phosphorus, exhibits about 10 times deteriorated moisture transmission resistivity and achieves no flame retardancy, even though the inorganic moisture absorbent is included with the same components and in the same amounts as in Example 1. Without being bound by theory, it is believed that since APP as a phosphorus-based flame retardant is present as a salt, unlike red phosphorus and the like, the moisture transmission resistivity is also deteriorated.

Although not shown in Table 1, an article manufactured by including the same type and the same amount of a base polymer, an inorganic moisture absorbent, and red phosphorus as a flame retardant as in Example 1, except for using expanded graphite having a lower thermal expansion starting temperature of 180° C. instead of the expanded graphite having a thermal expansion starting temperature of 200° C., exhibits moisture transmission resistivity similar to that of Example 1 but does not secure flame retardancy. It is believed that the expanded graphite expands at a lower temperature than an extrusion temperature of the article, and thus has no flame retardancy after manufactured into the article.

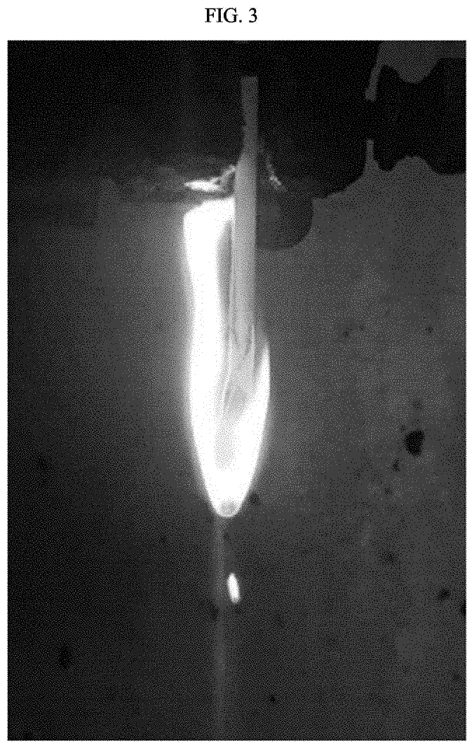

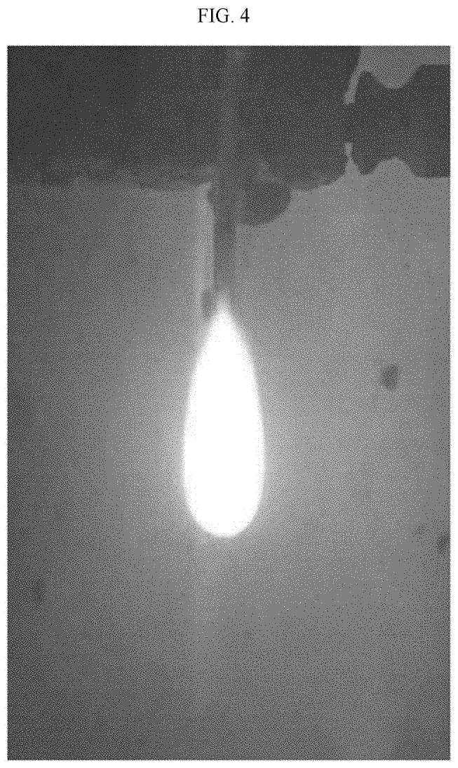

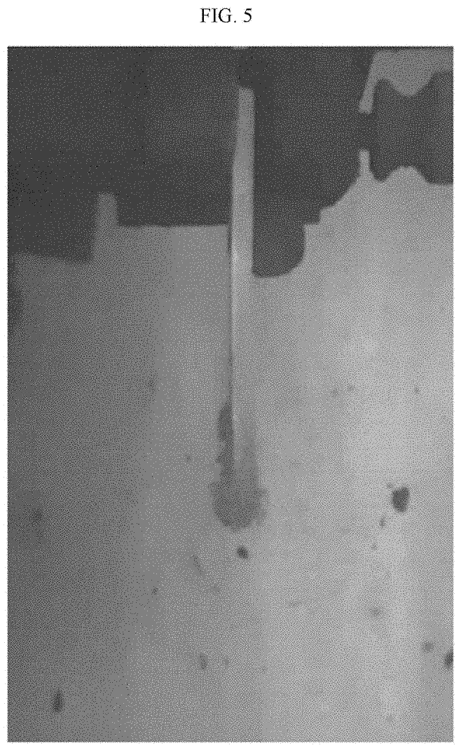

FIGS. 3 to 5 are photographs showing a process of a flame retardancy test according to UL-94 regarding a composite prepared by using a base polymer alone or adding an inorganic moisture absorbent and/or a flame retardant to the base polymer. Specifically, FIG. 3 is a test photograph showing an article manufactured by using HDPE alone as the base polymer. FIG. 4 is a flame retardancy test photograph showing a composite of Comparative Example 2 including 70 wt % of HDPE, 10 wt % of CaO as inorganic moisture absorbent, and 20 wt % of red phosphorus as a flame retardant, and FIG. 5 is a flame retardancy test photograph of a composite of Example 1 including 70 wt % of HDPE, 10 wt % of CaO as an inorganic moisture absorbent, and 10 wt % of red phosphorus and 10 wt % of expanded graphite as a flame retardant.

As shown in FIG. 3, when a flame goes relatively high around the article, the flame retardancy is not secured. Similarly, in FIG. 4, the flame retardancy is not secured, either. On the contrary, in FIG. 5, since a char at the bottom is formed which blocks oxygen and heat, a flame disappears, and accordingly, flame retardancy is secured.

As illustrated hereinbefore, an article including a composite including a base polymer, an inorganic moisture absorbent, and both expanded graphite and red phosphorus as a flame retardant according to an embodiment simultaneously secures excellent moisture transmission resistivity and flame retardancy, and thus may be used for a case for rechargeable lithium battery requiring these two properties and a rechargeable lithium battery or a battery module including the same.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A battery case comprising:
a container configured to accommodate an electrode assembly,
wherein the container comprises a bottom wall and a plurality of side walls, the bottom wall and the side walls are integrated to have an open side opposed to the bottom wall and to provide a space for accommodating the electrode assembly,
the container comprises a composite comprising a base polymer and an inorganic moisture absorbent, expanded graphite, and red phosphorus, each of which are dispersed in the base polymer, and
the battery case has a water vapor transmittance rate measured at about 38° C. under relative humidity of about 100% according to ISO 15106 or ASTM F1249 of less than about 0.07 gram per square meter per day and flame retardancy of V-0 measured according to UL (Underwriter's Laboratories)-94.

2. The battery case of claim 1, wherein the base polymer comprises a polycarbonate, a polyethylene, a polypropylene, a polyvinyl, a polyamide, a polyester, a polyphenylene sulfide, a polyphenylene ether, a polystyrene, a polyimide, a polycyclic olefin copolymer, an acrylonitrile-butadiene-styrene copolymer, a liquid crystal polymer, a mixture thereof, an alloy thereof, or a copolymer thereof.

3. The battery case of claim 1, wherein the base polymer comprises a polyolefin.

4. The battery case of claim 3, wherein the polyolefin comprises a high density polyethylene.

5. The battery case of claim 1, wherein the base polymer further comprises at least one of polytetrafluoroethylene, polyvinylidene fluoride, polychlorotrifluoroethylene, a mixture thereof, or a copolymer thereof.

6. The battery case of claim 1, wherein the inorganic moisture absorbent comprises a silica gel, a zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂, Ba(ClO₄)₂, Ca, or a mixture thereof.

7. The battery case of claim 1, wherein the inorganic moisture absorbent comprises CaO, MgO, a zeolite, or a mixture thereof.

8. The battery case of claim 1, wherein a thermal expansion start temperature of the expanded graphite is greater than or equal to an extrusion temperature of the base polymer.

9. The battery case of claim 1, wherein the base polymer comprises a high density polyethylene, and the thermal expansion start temperature of the expanded graphite is greater than or equal to about 200° C.

10. The battery case of claim 1, wherein the composite further comprises a moisture barrier material that is a crystalline form of the same polymer as or a different polymer from the base polymer, a particle of an inorganic material different from the inorganic moisture absorbent, or a fiber-shaped material.

11. The battery case of claim 10, wherein the moisture barrier material comprises wollastonite, mica, a cellulose whisker, barium sulfate, kaolin, talc, nanoclay, a carbon fiber, a glass fiber, or a mixture thereof.

12. The battery case of claim 1, wherein the base polymer is included in an amount of about 30 wt % to about 85 wt % based on a total weight of the composite.

13. The battery case of claim 1, wherein the inorganic moisture absorbent is included in an amount of less than about 30 wt % based on a total weight of the composite.

14. The battery case of claim 1, wherein the expanded graphite is included in an amount of less than or equal to about 30 wt % based on a total weight of the composite.

15. The battery case of claim 1, wherein the red phosphorus is included in an amount of less than or equal to about 25 wt % based on a total weight of the composite.

16. The battery case of claim 1, wherein the container comprises a plurality of cell compartments separated by at least one partition wall disposed in the space.

17. The battery case of claim 1, wherein the battery case further comprises a lid configured to cover at least a portion of the open side of the container and having at least one of a positive terminal and a negative terminal.

18. The battery case of claim 17, wherein the lid comprises the same composite as the container.

19. A battery comprising
the battery case of claim 1, and
an electrode assembly comprising a positive electrode and a negative electrode accommodated in the container of the battery case.

20. The battery of claim 18, wherein the electrode assembly is for a rechargeable lithium battery.
